(19) United States
(12) Patent Application Publication
(10) Pub. No.: US 2018/0225563 A1
(43) Pub. Date: Aug. 9, 2018

(54) ARTIFICIAL NEURAL NETWORK DEVICE AND OPERATION METHOD THEREOF

(71) Applicant: ELECTRONICS AND TELECOMMUNICATIONS RESEARCH INSTITUTE, Daejeon (KR)

(72) Inventors: Ju-Yeob KIM, Daejeon (KR); Byung Jo KIM, Sejong (KR); Jin Kyu KIM, Sejong (KR); Mi Young LEE, Daejeon (KR); Seong Min KIM, Daejeon (KR); Joo Hyun LEE, Daejeon (KR)

(21) Appl. No.: 15/868,889

(22) Filed: Jan. 11, 2018

(30) Foreign Application Priority Data
Feb. 8, 2017 (KR) 10-2017-0017745

(51) Int. Cl. G06N 3/04; G06N 3/08

(52) U.S. Cl. CPC G06N 3/049; G06N 3/08

(57) ABSTRACT

Provided is an artificial neural network device including pre-synaptic neurons configured to generate a plurality of input spike signals, and a post-synaptic neuron configured to receive the plurality of input spike signals and to generate an output spike signal during a plurality of time periods, wherein the post-synaptic neuron respectively applies different weights in the plurality of time periods according to contiguousness with a reference time period in which input spike signals, which lead generation of the output spike signal from among the plurality of input spike signals, are received.

### CROSS-REFERENCE TO RELATED APPLICATIONS

This U.S. non-provisional patent application claims priority under 35 U.S.C. § 119 of Korean Patent Application No. 10-2017-0017745, filed on Feb. 8, 2017, the entire contents of which are hereby incorporated by reference.

### BACKGROUND

The present disclosure herein relates to an artificial neural network device, and more particularly, to an artificial neural network device to which weights are applied according to a timing at which input spike signals are received.

The present disclosure herein also relates to an operation method of an artificial neural network device, and more particularly, to an operation method of an artificial neural network device to which weights are applied according to a timing at which input spike signals are received.

Nowadays, with the development of artificial intelligence (AI), an artificial neural network is also being actively studied. The function or performance of an artificial neural network is determined according to connection strengths between perceptrons that are logical operation units of the artificial neural network. The connection strengths between perceptrons have been modeled as multiplication of input data of the perceptrons and weights (or learned parameter values). According to such an existing modeling method, there is a problem in that all neurons providing the artificial neural network device are synchronized at the same time, or weights are determined only with magnitudes of input signals of the neurons (or output signals from the neurons).

Typically, biological neurons providing the nervous system of a human being or an animal depend on timing information of an input/output of spike signals. In other words, not also magnitudes of the spike signals, but a timing of input/output of the spike signals is also important. Accordingly, it is very important to develop an artificial neural network device capable of implementing Spike Time Dependent Plasticity (STDP) that is a learning method occurring in the nervous system of a human being.

### SUMMARY

The present disclosure provides an artificial neural network device for implementing in detail the brain of a human being by applying weights of various values according to a timing when input spike signals are received, and an operation method thereof.

An embodiment of the inventive concept provides an artificial neural network device includes: pre-synaptic neurons configured to generate a plurality of input spike signals; and a post-synaptic neuron configured to receive the plurality of input spike signals and to generate an output spike signal during a plurality of time periods, wherein the post-synaptic neuron respectively applies different weights in the plurality of time periods according to contiguousness with a reference time period in which input spike signals, which lead generation of the output spike signal from among the plurality of input spike signals, are received.

In an embodiment of the inventive concept, a method of operation an artificial neural network, which includes a synaptic neuron configured to generate an output spike signal on a basis of a plurality of input spike signals input for each of a plurality of time periods, includes: detecting a reference time period, from among the plurality of time periods, in which input spike signals leading generation of the output spike signal are received; applying, according to contiguousness with the reference time period, different weights to the input spike signals input in a time period after the reference time period from among the plurality of time periods; and generating the output spike signal on a basis of the input spike signals to which the different weights are applied.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram for schematically showing an artificial neural network device according to an embodiment of the inventive concept;

FIG. 2 is a drawing for showing in detail that a post-synaptic neuron shown in FIG. 1 reflects a weight according to a time period;

FIG. 3 is a block diagram for showing in detail a structure of a post-synaptic neuron according to an embodiment of the inventive concept;

FIG. 4 is a block diagram showing any one of first to k-th weight operation units shown in FIG. 3;

FIG. 5 is a block diagram showing in detail a configuration of a spike signal generating unit shown in FIG. 3; and

FIG. 6 is a flowchart showing an operation method of an artificial neural network device according to an embodiment of the inventive concept.

### DETAILED DESCRIPTION

Hereinafter, an exemplary embodiment of the present disclosure will be described in detail with reference to the accompanying drawings such that a person skilled in the art may easily carry out the embodiments of the present disclosure.

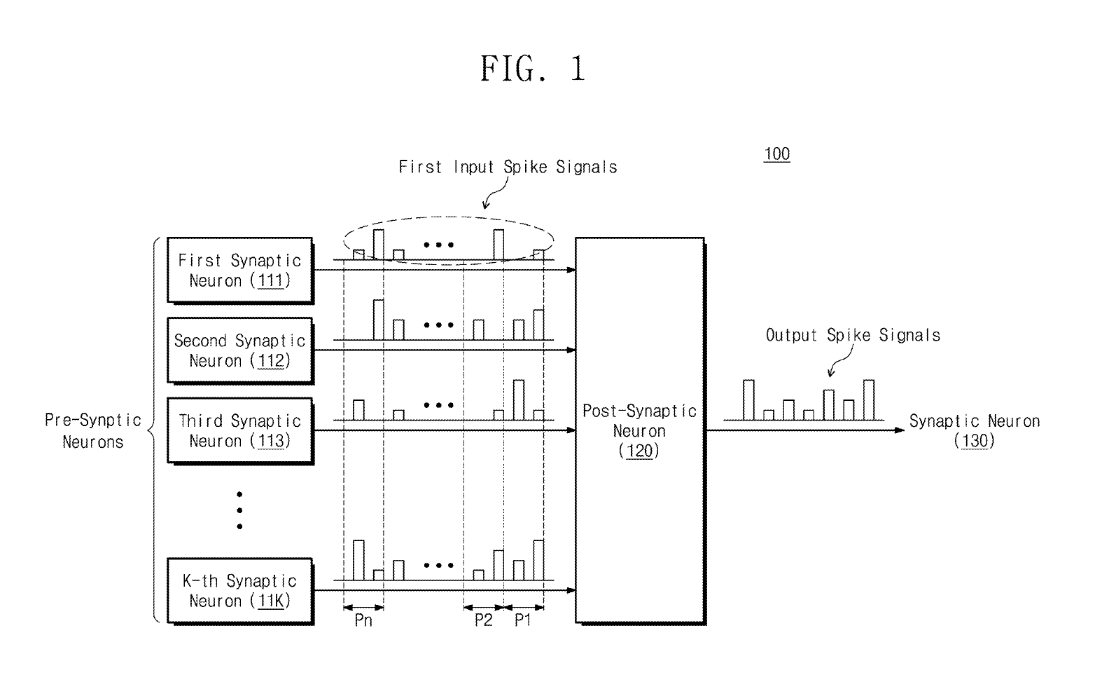

FIG. 1 is a block diagram for schematically showing an artificial neural network device 100 according to an embodiment of the inventive concept. The artificial neural network device 100 may include a plurality of synaptic neurons 111 to 11k, 120 and 130 intertwined with each other to provide a network.

Each of the plurality of synaptic neurons 111 to 11k, 120 and 130 may have a substantially identical structure. However, the synaptic neurons may be called with different names according to locations at which the synaptic neurons are disposed or views in connection to other synaptic neurons. For example, a synaptic neuron configured to generate a spike signal and deliver the spike signal to another synaptic neuron may be called as a pre-synaptic neuron (e.g. any one of reference numerals 111 to 11k). for example, a neuron configured to receive the spike signal and generate a new spike signal may be called as a post-synaptic neuron (e.g. 120).

Each of the plurality of pre-synaptic neurons 111 to 11k may be configured to generate a plurality of spike signals. For example, a first synaptic neuron 111 may receive spike signals from other synaptic neurons (not shown) to generate first input spike signals, and may deliver the first input spike signals to the post synaptic neuron 120. Similarly, second to k-th synaptic neurons 112 to 11k may also respectively generate second to k-th input spike signals to deliver the generated spike signals to the post-synaptic neuron 120.

The post-synaptic neuron 120 may receive the plurality of spike signals from the first to k-th synaptic neurons. The post-synaptic-neuron 120 may generate output spike signals on the basis of timing information that the plurality of spike signals are input. For example, the post-synaptic neuron 120 may apply different weights to the spike signals input in each time period.

The post-synaptic neuron 120 may generate an output spike signal, when received and accumulated to one spike signal exceed a specific threshold value. If the output spike signal is generated by the spike signals input to the post-synaptic neuron 120, the spike signals input to the pose-synaptic neuron 120 are inputs having significant correlations with the output spike signal. Accordingly, in this case, weights may be applied to spike signals input in a next time period.

The post-synapse neuron 120 may calculate an influence (namely, a weight) of a first input spike signal input in a first time period P1 on generation of the output spike signal. In addition, the post-synaptic neuron 120 may reflect the calculated weight to the first spike signal input in a second time period P2. Similarly, the post-synaptic neuron 120 may calculate an influence (namely, a weight) of a k-th input spike signal input in the first time period P1 on the generation of the output spike signal. Furthermore, the post-synaptic neuron 120 may reflect the calculated weight to the k-th spike signal input in the second time period P2.

For example, the post-synaptic neuron 120 may apply relatively larger weights, as a time period (e.g. the first time period P1) is closer to a time period (e.g. a reference time period) in which the input spike signals leading the generation of the output spike signal are input. On the contrary, the post-synaptic neuron 120 may apply relatively smaller weights, as a time period (e.g. an n-th first time period Pn) is farther from the time period (e.g. the reference time period) in which the input spike signals leading the generation of the output spike signal are input.

For example, during the reference time period, when magnitudes of the spike signals input to the post-synaptic neuron 120 are relatively large, the post-synaptic neuron 120 may apply relatively larger weights to spike signals input in a next time period (e.g. the first time period P1). On the contrary, during the reference time period, when the magnitudes of the spike signals input to the post-synaptic neuron 120 are relatively smaller, the post-synaptic neuron 120 may apply relatively small weights to the spike signals input in the next time period (e.g. the first time period P1).

Although two spikes are shown as received by each synaptic neuron in one time period in the drawing, the inventive concept is not limited thereto. For example, a time period in which one or more various numbers of spike signals are received may be set to one time period. In addition, the time period length may be determined by various conditions such as a specification of a device or system to which the inventive concept is applied, or may be changed in real time.

An artificial neural network, which realizes in detail the brain of a human being, may be implemented by calculating the weights in consideration of the input timing of the spike signals as well as the magnitudes of the spike signals, and reflecting the weights on generation of the output spike signals.

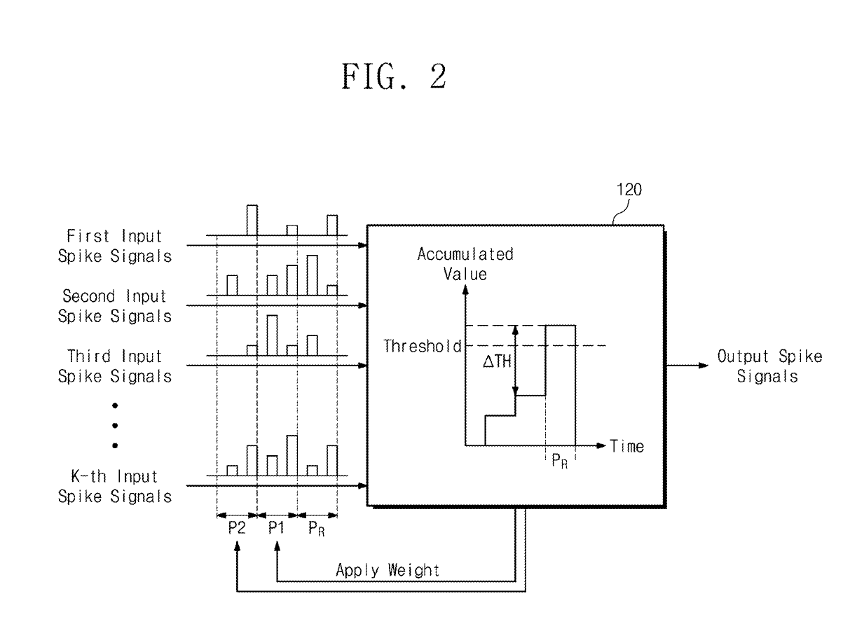

FIG. 2 is a drawing for showing in detail that the post-synaptic neuron 120 shown in FIG. 1 reflects weights according to a time period. Referring to FIG. 2, after the input spike signals are input in a time period PR, the input spike signals are input in the time period P1. Then, the input spike signals are input in a time period P2.

When the spike signals input in each time period are input to the post-synaptic neuron 120, the post-synaptic neuron 120 may accumulate the spike signals. However, although the spike signals are received, the post-synaptic neuron 120 does not generate the output spike signal immediately. For example, the post-synaptic neuron 120 may generate the output spike signal, when a value of the accumulated spike signals exceeds a specific threshold value.

For example, as shown in the drawing, it is assumed that the accumulated value exceeds the threshold value by a value ΔTH of the spike signal accumulated in the time period PR. When the output spike signal is generated due to the accumulated value exceeding the threshold value, the time period PR may be referred as a reference time period. In other words, the reference time period may be a time period in which the input spike signals leading generation of the output spike signal are received.

The post-synaptic neuron 120 of the inventive concept may apply relatively larger weights to the input spike signals received in the first time period P1 after the reference time period PR in which the output spike signal is generated. Of course, even in the first time period P1, the weights applied to the first input spike signal to the k-th input spike signal may be different from each other.

In addition, the post-synaptic neuron 120 of the inventive concept may apply relatively smaller weights to the input spike signals received in the second time period P2 after the first time period P1. Of course, even in the second time period P2, the weights applied to the first input spike signal to the k-th input spike signal may be different from each other.

Putting together the above-described, relatively larger weights are applied to the input spike signals received in a time period closer to the reference time period PR. On the contrary, relatively smaller weights are applied to the input spike signals received in a time period farther from the reference time period PR.

Besides the application of the weights in this way, other schemes may be considered. For example, when a variation amount ΔTH in the spike signal value accumulated in the first time period P1 is relatively larger, the post-synaptic neuron 120 may calculate relatively larger weights. In addition, the calculated weights may be applied to accumulate the spike signals input in the second time period P2. On the other hand, when the variation amount ΔTH of the spike signal value accumulated in the first time period P1 is relatively smaller, the post-synaptic neuron 120 may calculate relatively smaller weights. In addition, the calculated weights may be applied to accumulate the spike signals input in the second time period P2.

A process in which weights calculated in a specific time period are applied to the spike signals input in a next time period may be consecutively executed. For example, the weights calculated in the first time period P1 may be applied to accumulate the spike signals input in the second time period P2. The weights calculated in the second time period P2 may be applied to accumulate spike signals input in a third time period P3 (not shown). Similarly, although not shown in the drawing, weights calculated in an (n−1)-th time period Pn−1 may be applied to accumulate the spike signals input in the n-th time period Pn (referring to FIG. 1).

On the other hand, a weight may have a positive value or a negative value. For example, when an influence of spike signals input in a specific time period on generation of the output spike signal is very small or minor, the post-synaptic neuron 120 may generate weights having negative values.

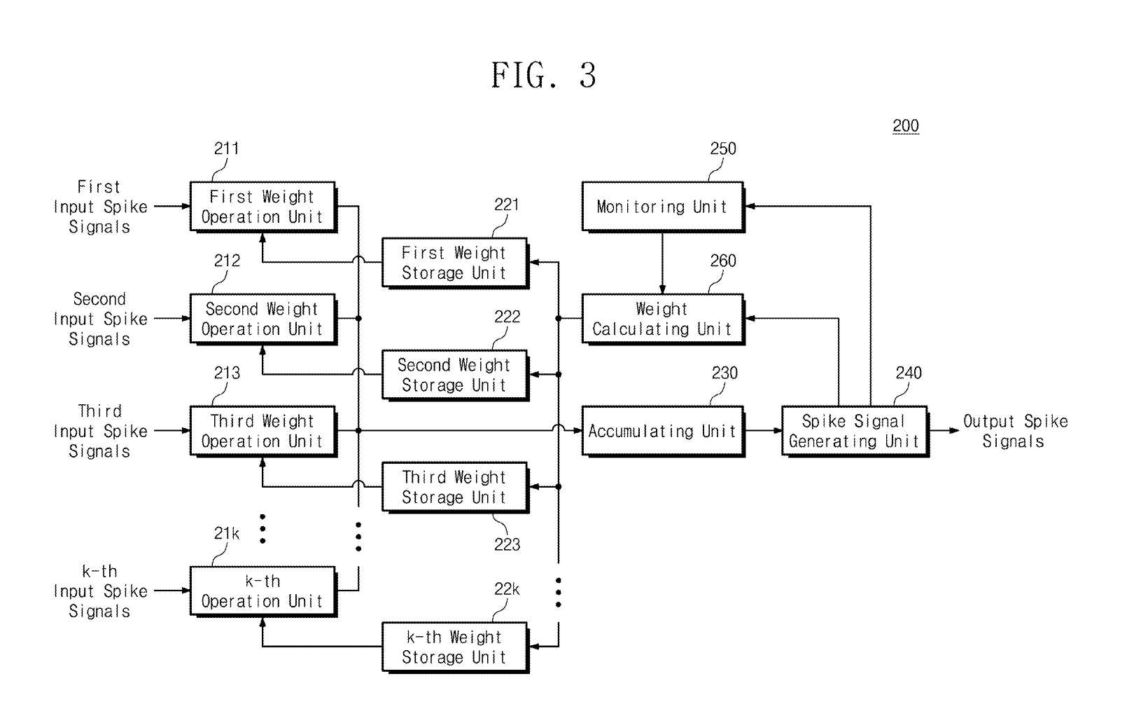

FIG. 3 is a block diagram for showing in detail a structure of the post-synaptic neuron 200 according to an embodiment of the inventive concept. The pre-synaptic neurons 111 to 11k (see FIG. 1) and the synaptic neuron 130 (see FIG. 1) may have substantially the same structure as shown in FIG. 3. For ease of understanding, the description will be provided in relation to FIGS. 1 and 2.

The post-synaptic neuron 200 may include a plurality of weight operation units 211 to 21k, a plurality of weight storage units 221 to 22k, an accumulating unit 230, a spike signal generating unit 240, a monitoring unit 250, and a weight calculating unit 260.

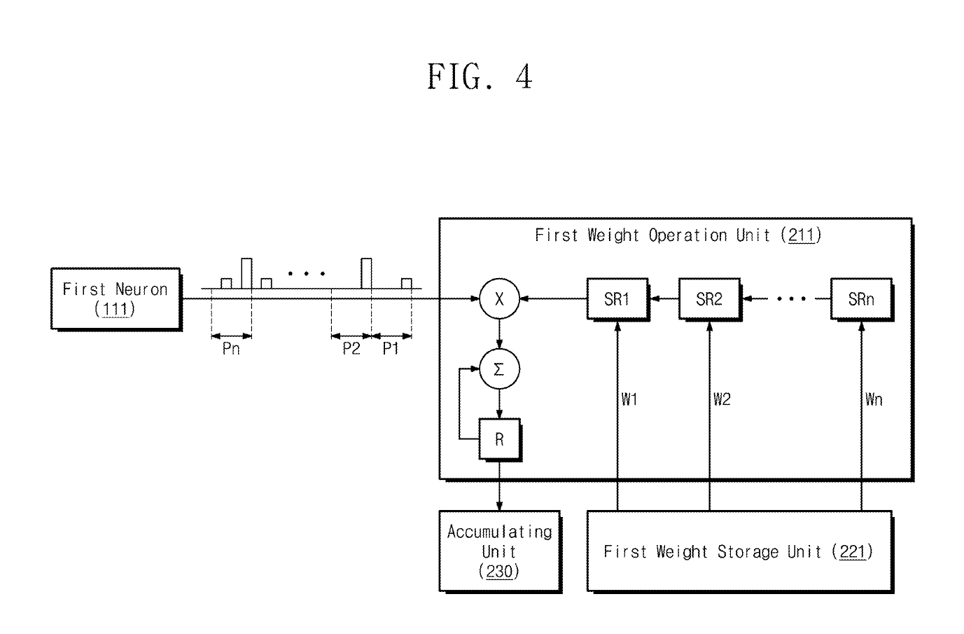

The weight operation units 211 to 21k may respectively receive spike signals and apply weights to the spike signals. For example, a first weight operation unit 211 may apply a weight to the first input spike signal, and the weight may be different for each time period. For example, a relatively large weight may be applied in a time period that is closer to a time period in which spike signals relatively significantly attribute to the generation of the output spike signal. A detailed structure and an operation of the weight operation units 211 to 21k will be described in relation to FIG. 4.

The weight storage units 221 to 22k may store weights necessary for the weight operation units 211 to 21k to calculate the weights. For example, the weight operation units 211 to 21k may respectively receive corresponding weights from the weight calculating unit 260. For example, the weight storage units 221 to 22k may include various storage elements such as a register, a static random access memory (SRAM), a dynamic random access memory (DRAM), or a phase-change memory (PRAM). However, a configuration of the weight storage units 221 to 22k is not limited thereto.

The accumulating unit 230 may receive values respectively operated by the weight operation units 211 to 21k. For example, the values received by the accumulating unit 230 may be magnitudes of the spike signals, to which the weights are reflected.

The spike signal generating unit 240 may generate a spike signal on the basis of the value accumulated by the accumulating unit 230. For example, the spike signal generating unit 240 may be configured to generate the spike signal of various types such as a rectangular pulse, a pulse, or an impulse. For example, the spike signal generating unit 240 may be configured to generate the spike signal, when the accumulated value exceeds a specific threshold value.

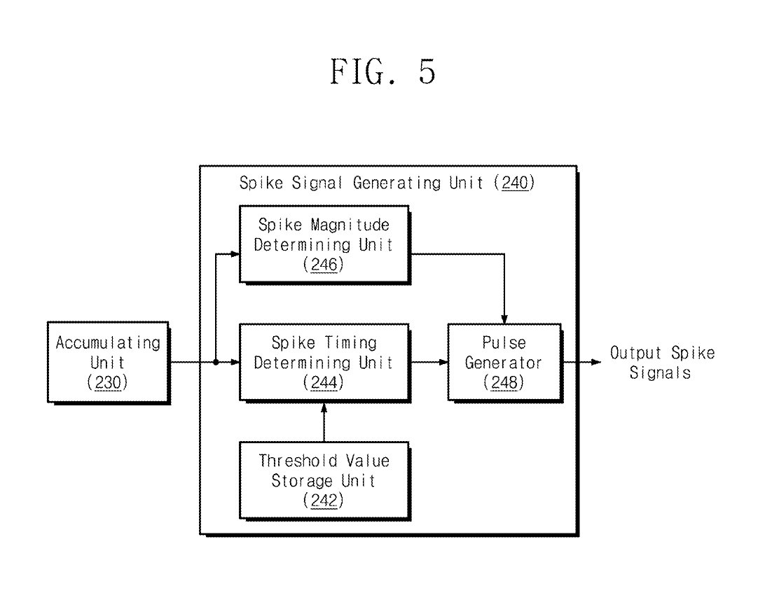

On the other hand, in the present embodiment, although the accumulating unit 230 and the spike signal generating unit 240 are illustrated as functional blocks separated from each other, a function of the accumulating unit 230 may be included in the spike signal generating unit 240. In this case, the accumulating unit 230 and the spike signal generating unit 240 may be implemented with a single hardware circuit and/or software (firmware). For example, the spike signal generating unit 240 may accumulate the values of the spike signals to which the weights are applied, and be configured to generate the spike signal according to whether the accumulated value exceeds the specific threshold value. The detailed configuration of the spike signal generating unit will be described in relation to FIG. 5.

The monitoring unit 250 may monitor, in real time, the value accumulated in the accumulating unit 230 or whether the output spike signal is generated. For example, when the input spike signals are received which have a large influence on the generation of the output spike signal, the monitoring unit 250 may generate a signal for performing a conversion on or calculating the weights.

The weight calculating unit 260 may calculate the weights in response to the signal generated by the monitoring unit 250. For example, the weight calculating unit 260 may respectively calculate the weights for the first to k-th weight operation units 211 to 21k. For example, as the input spike signals are input in a time period closer to the reference time period PR, the weight calculating unit 260 may calculate relatively large weights. On the contrary, as the input spike signals are input in a time period farther from the reference time period PR, the weight calculating unit 260 may calculate relatively small weights. The calculated weights may be stored in the first to k-th storage units 221 to 22k.

Furthermore, even though the output spike signal is generated by the spike signals input in the reference time period PR, the weight calculating unit 260 may calculate the various weights according to a magnitude of the variation amount (ΔTH, see FIG. 2) of the accumulated value. For example, as the variation amount (ΔTH) of the accumulated value in the reference time period PR is relatively larger, the weight calculating unit 260 may calculate relatively larger weights. On the contrary, as the variation amount (ΔTH) of the accumulated value in the reference time period PR is relatively smaller, the weight calculating unit 260 may calculate relatively smaller weights. The calculated weights may be stored in the first to k-th storage units 221 to 22k.

Meanwhile, in the present embodiment, although the monitoring unit 250 and the weight calculating unit 260 are illustrated with functional blocks separated from each other, in another example, a function of the monitoring unit 250 may be included in the weight calculating unit 260. In this case, the monitoring unit 250 and the weight calculating unit 260 may be implemented with a single hardware circuit and/or software (firmware). For example, the weight calculating unit 260 may be configured to monitor whether the spike signal generating unit 240 generates the output spike signal or whether the input spike signals having a strong influence on the generation of the output spike signal are received, etc., and to calculate the weights on the basis of the monitored result.

The post-synaptic neuron 200 of an embodiment of the inventive concept may be implanted with hardware, software, and/or a combination of hardware and software. For example, the post-synaptic neuron 200 may be implemented with a semiconductor chip or a hardware module, etc. Alternatively, the post-synaptic neuron 200 may be implemented with software or firmware loaded to a memory (e.g., DRAM) to be realized by a processor. Alternatively, the post-synaptic neuron 200 may be implemented with a processor, a controller, an arithmetic logic unit (ALU), a digital signal processor, a field programmable gate array (FPGA), or a programmable logic unit (PLU), etc.

FIG. 4 is a block diagram showing any one of the first to k-th weight operation units 221 to 22k illustrated in FIG. 3. As an example, a configuration of a first weight operation unit 221 is illustrated, and configurations of other weight operation units are substantially the same. The first weight operation unit 211 may include a plurality of shift registers SR1 to SRn, a multiplier X, an adder Σ, and a register R. For ease of understanding, a first neuron 111, a first weight storage unit 221, and the accumulator 230 are illustrated together, and the first time period is a time period after the reference time period in which the output spike signal is generated.

The shift registers SR1 to SRn may store weights W1 to Wn stored in the first weight storage unit 221. For example, the shift register SR1 may store the weight W1 corresponding to the first time period P1. The shift register SR2 may store the weight W2 corresponding to the second time period P2. Similarly, the shift register SRn may store the weight Wn corresponding to the n-th time period Pn.

Although not illustrated in the drawing, the shift registers SR1 to SRn are synchronized with an activation time of a clock through which the shift registers SR1 to SRn operate to shift weights W1 to Wn, sequentially. Since a shifting operation of the shift registers SR1 to SRn is well known to a person skilled in the art, a detailed description will be omitted.

The multiplier X may multiply a value of an input spike signal received in each time period (any one of P1 to Pn) by the weight corresponding to the time period. As the time periods sequentially elapse from P1 to Pn, the shifting operation by the shift registers SR1 to SRn may be sequentially performed. For example, the multiplier X may multiply the input spike signal input in the first time period P1 by the weight W1. Then, in the second time period P2, the weight W2 stored in the shift register SR2 may be shifted to the shift register SR1. In addition, the multiplier X may multiply the input spike signal input in the second time period P2 by the weight W2. Finally, in the n-th time period Pn, the weight Wn stored in shift register SRn may be shifted to the shift register SR1. Furthermore, the multiplier X may multiply the input spike signal input in the n-th time period Pn by the weight Wn.

Meanwhile, according to an embodiment, a device for measuring the magnitude of the spike signal may be additionally provided to an input end of the first weight operation unit 211, to which the first spike signal is input.

The adder Σ may add up multiplication results (i.e., from the value obtained by multiplying the weight W1 by the input spike signal value input in the first time period P1 to a value obtained by multiplying the weight Wn by the input spike signal value input in the n-th time period Pn) of the multiplier X.

The register R may store the addition result from the adder. In addition, the stored addition result may be used when the adder Σ adds up the multiplication results from the multiplier X. The addition result stored in the register R will be delivered to the accumulating unit 230.

The multiplier X, the adder Σ, and the register R illustrated in the drawing are exemplary. In other words, various configurations may be used for multiplying the value of the input spike signal received in a specific time period (e.g. P1) and the weight (e.g. W1) corresponding thereto, and for adding and accumulating the multiplication results. In addition, the technical idea of the present disclosure also include various configurations for multiplying the input spike signal value received the specific time period (e.g. P1) and the weight (e.g. W1) corresponding thereto, and for adding and accumulating the multiplication results.

FIG. 5 is a block diagram showing in detail a configuration of the spike signal generating unit 240 illustrated in FIG. 3. The spike signal generating unit 240 may include a threshold value storage unit 242, a spike timing determining unit 244, a spike magnitude determining unit 246, and a pulse generator 248. For ease of understanding, the description will be provided in relation to FIG. 3 in which an accumulator 230 is also illustrated.

The threshold value storage unit 242 may store a threshold value for generating the output spike signal. The threshold value may be pre-determined. Alternatively, the threshold value may vary according to various factors such as a specification of an artificial neural network of the inventive concept and a specification of a system to which the artificial neural network of the inventive concept is applied.

The spike timing determining unit 244 may determine whether to generate the output spike signal (i.e. a timing at which the output spike signal is generated). For example, the spike timing determining unit 244 may compare the value accumulated in the accumulating unit 230 with the threshold value stored in the threshold value storage unit 242. The spike timing determining unit 244 may generate a signal for controlling the pulse generator 248 such that the spike signals are generated, when the value accumulated in the accumulator 230 is greater than the threshold value stored in the threshold value storage unit 242.

The spike magnitude determining unit 246 may determine the magnitude of the output spike signal to be generated by the pulse generator 248 on the basis of the value accumulated in the accumulator 230. For example, the magnitude of the output spike signal to be generated may be determined in consideration of various elements such as an influence of the input spike signals on the generation of the output spike signal, a correlation between the input spike signals and the output spike signal, and a learned result by the post-synaptic neuron 200.

The pulse generator 248 may generate the output spike signal on the basis of the output signals of the spike timing determining unit 244 and the spike magnitude determining unit 246. Although called as a pulse generator, the pulse generator 248 may be configured to generate various types of spike signals such as a rectangular wave, a pulse, or an impulse.

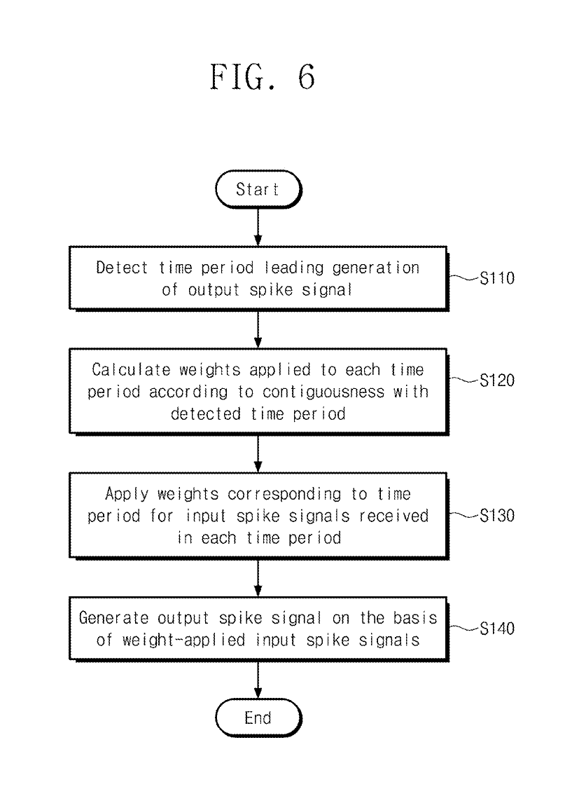

FIG. 6 is a flowchart showing an operation method of an artificial neural network device according to an embodiment of the inventive concept. For ease of understanding, a description will be provided in relation to FIGS. 3 to 5 together.

In operation S110, a time period may be detected in which the output spike signal is led to be generated. For example, it is assumed that the output spike signal is generated by the input spike signals received in a reference time period before the first time period P1. In this case, the monitoring unit 250 may detect the generation of the output spike signal.

In operation S120, weights applied to each time period may be calculated according to a degree of contiguousness and the detected time period. For example, the weight calculating unit 260 may calculate relatively large weights for the input spike signals received in the first time period P1 that is most adjacent to the reference time period. On the contrary, the weight calculating unit 260 may calculate relatively small weights for the input spike signals received in the n-th time period Pn that is far from the reference time period.

In operation S130, the weights corresponding to each time period may be applied to the input spike signals received in the time period. For example, the weights W1 may be applied to the input spike signals received in the first time period P1. Similarly, the weights Wn may be applied to the input spike signals received in the n-th time period Pn.

For example, a process in which the weights are applied to the input spike signals may be performed by the shift registers SR1 to SRn, the multiplier X, the adder Σ, and the register R, etc.

Naturally, this means that the relatively large weights W1 are applied in the first time period P1, but does not mean that a weight applied to the first input spike signal received in the first time period P1 is not equal to a weight applied to the k-th input spike signal received in the first time period P1. In other words, different weights may be applied to the first input spike signal to the k-th input spike signal received in the same time period (e.g. P1). This may be determined in consideration of various elements such as the influence of the input spike signals on the generation of the output spike signal, the correlation between the input spike signals and the output spike signal, and the learned result by the post-synaptic neuron 200.

In operation S140, the output spike signal may be generated on the basis of the input spike signals to which different weights are applied.

For example, the accumulator 230 may sequentially accumulate the input spike signals to which different weights are applied according to the time period and from which synaptic neuron the input spike signal is received (e.g. whether to be received in P1 and/or whether to be the first input spike signal).

In addition, the spike signal generating unit 240 may generate the output spike signal according to whether the value accumulated by the accumulating unit 230 exceeds the threshold value.

According to an artificial neural network based on the above-described embodiment of the inventive concept, weights may be calculated in consideration of an input timing of spike signals as well as magnitudes of the spike signals input to a post-synaptic neuron. As a result, the artificial neural network may be implemented which copies in detail the brain of a human being.

The foregoing description is about detailed examples for practicing the inventive concept. The present disclosure includes not only the above-described embodiments but also simply changed or easily modified embodiments. In addition, the inventive concept may also include technologies obtained by easily modifying and practicing the above-described embodiments.

According to an artificial neural network device based on an embodiment of the inventive concept, an artificial neural network device for specifically implementing the brain of a human being by applying weights of various values according to a timing when input spike signals are received, and an operation method thereof may be provided.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An artificial neural network device comprising:
pre-synaptic neurons configured to generate a plurality of input spike signals; and
a post-synaptic neuron configured to receive the plurality of input spike signals and to generate an output spike signal during a plurality of time periods,
wherein the post-synaptic neuron respectively applies different weights in the plurality of time periods according to contiguousness with a reference time period in which input spike signals, which lead generation of the output spike signal from among the plurality of input spike signals, are received.

2. The artificial neural network device of claim 1, wherein a first weight is applied to input spike signals received from among the plurality of input spike signals in a first time period after the reference time period, and
a second weight is applied to input spike signals received in a first time period after the reference time period in a second time period after the reference time period.

3. The artificial neural network device of claim 2, wherein the first weight is larger than the second weight.

4. The artificial neural network device according to claim 2, wherein a first weight has a positive value and a second weight has a negative value.

5. The artificial neural network device of claim 2, wherein the post-synaptic neuron comprises:
a weight operation unit configured to:
apply the first weight to the input spike signals received from among the plurality of input spike signals in the first time period; and
apply the second weight to the input spike signals received from among the plurality of input spike signals in the second time period.

6. The artificial neural network device of claim 5, wherein the weight operation unit comprises:
first and second shift registers configured to respectively store the first and second weights;
a multiplier configured to multiply the input spike signals received in the first time period by the first weight, and to multiply the input spike signals received in the second time period by the second weight;
an adder configured to add multiplication results of the multiplier; and
a register configured to store an addition result of the adder.

7. The artificial neural network device of claim 6 further comprising:
an accumulator configured to accumulate the input spike signals received during the reference time period;
a spike signal generating unit configured to generate the output spike signal according to whether an accumulation result by the accumulator exceeds a threshold value; and
a calculating unit configured to calculate the first weight and the second weight according to whether the output spike signal is generated.

8. The artificial neural network device of claim 7, further comprising:
a weight storage unit configured to store the first weight and the second weight and to provide the stored weights to the weight operation unit.

9. The artificial neural network device of claim 7, wherein the spike signal generating unit comprises:
a spike timing determining configured to determine whether to generate the output spike signal on a basis of the accumulation result by the accumulating unit;
a spike magnitude determining unit configured to determine a magnitude of the output spike signal; and
a pulse generator configured to generate the output spike signal on a basis of determination results of the spike timing determining unit and the spike magnitude determining unit.

10. The artificial neural network device of claim 9, wherein the spike signal generating unit further comprises a threshold value storage unit configured to store the threshold value,
wherein the threshold value is a pre-determined or a variable value.

11. The artificial neural network device of claim 1, wherein as input spike signals are received from among the plurality of input spike signals in a time period closer to the reference time period, a larger weight is applied, and
as input spike signals are received from among the plurality of input spike signals in a time period farther from the reference time period, a smaller weight is applied

12. A method of operation an artificial neural network, which comprises a synaptic neuron configured to generate an output spike signal on a basis of a plurality of input spike signals input for each of a plurality of time periods, the operation method comprising:
detecting a reference time period, from among the plurality of time periods, in which input spike signals leading generation of the output spike signal are received;
applying, according to contiguousness with the reference time period, different weights to the input spike signals input in a time period after the reference time period from among the plurality of time periods; and
generating the output spike signal on a basis of the input spike signals to which the different weights are applied.

13. The method of claim 12, wherein the applying of the weights comprises:
applying a first weight to input spike signals received in a first time period after the reference time period from among the plurality of spike signals; and
applying a second weight smaller than the first weight to input spike signals received in a second time period after the first time period from among the plurality of spike signals.

14. The method of claim 12, wherein the detecting of the reference time period comprises:
determining whether an accumulated input spike signal exceed a threshold value; and
selecting, as the reference time period, a time period in which input spike signals leading to exceed the threshold value are input.

15. The method of claim 12, wherein the generating of the output spike signal comprises:
determining a generation timing of the output spike signal on a basis of whether the accumulated input spike signal exceeds the threshold value;
determining a magnitude of the output spike signal; and
generating the output spike signal on a basis of the determined generation timing of the spike signals and the determined magnitude of the output spike signal.
